(19) United States
(12) Patent Application Publication
(10) Pub. No.: US 2012/0088024 A1
(43) Pub. Date: Apr. 12, 2012

(54) TASTE-IMPROVING AGENT FOR POTASSIUM SALT OR POTASSIUM SALT-CONTAINING FOOD OR DRINK

(75) Inventors: Tsukasa Saito, Kanagawa (JP); Kenji Haraguchi, Kanagawa (JP)

(73) Assignee: T. HASEGAWA CO., LTD., Tokyo (JP)

(21) Appl. No.: 13/239,773

(22) Filed: Sep. 22, 2011

(30) Foreign Application Priority Data
Oct. 6, 2010 (JP) 2010-226817

(51) Int. Cl. A23L 1/226

(52) U.S. Cl. 426/536

(57) ABSTRACT

The present invention relates to improvement of the unpleasant taste characteristic of potassium salts without adversely affecting the salty taste of the potassium salts and provides a method for reducing sodium contents in foods and drinks without reducing salty taste of the foods and drinks and also provides sodium-reduced foods and drinks. The present invention relates to a taste-improving agent for a potassium salt or a potassium salt-containing food or drink, and the agent contains a phthalide as an active ingredient.

### TECHNICAL FIELD

The present invention relates to a taste-improving agent, more specifically, a taste-improving agent that can reduce unpleasant tastes such as metallic tastes and acrid tastes derived from potassium salts, without reducing the salty tastes of potassium salts or potassium salt-containing foods or drinks and without altering the original flavor properties of the foods or drinks.

### DESCRIPTION OF THE RELATED ART

A salty taste is one of five primary tastes that are important for good tastes and is usually derived from sodium chloride (salt). Salt is an important material involved in improvement of, for example, storage lives and physical properties of foods and drinks. However, excessive salt intake has been thought to be a problem in relation with lifestyle-related diseases. It is believed that continuous excessive intake of salt causes accumulation of sodium in the body to increase the water content in the blood vessels, resulting in a rise in blood pressure. Thus, it is common knowledge today that habitual excessive intake of salt is closely related to pathogenesis of hypertension. Furthermore, excessive salt intake is concerned to cause other complications (such as cardiac diseases and renal diseases), and global efforts to reduce salt intake have therefore arisen in recent years. According to national nutrition surveys, Japanese intake of salt is reported to be approximately 11 to 14 g per day, and the Ministry of Health, Labor and Welfare in Japan advises a salt intake of not greater than 10 g per day. In the U.S. and Europe, the recommended target intake is 6 g per day, and the “guidelines for treatment of hypertension” by the Japanese Society of Hypertension indicates a preferred salt intake of not greater than 6 g per day, based on the WHO and U.S./European standard.

Accordingly, many attempts have been proposed in recent years to reduce the salt contents in foods and drinks, that is, a reduction in the amount of salt has been attempted by enhancing salty taste. One method known for enhancing salty taste without impairing the original flavor of foods or drinks involves enhancing salty taste with a composition containing spiranthol (Japanese Examined Patent Application Publication No. Sho 48-35465). Unfortunately, though this method can enhance salty taste to some degree, the lack of overall flavor caused by reducing the sodium content cannot be sufficiently supplemented.

Alternatively, a method for relatively reducing the sodium contents in foods and drinks by partially replacing the salt in the foods and drinks with potassium chloride or bittern (mixture of magnesium chloride, calcium chloride, and so on), which has salty taste, has been proposed (Japanese Unexamined Patent Application Publication No. Sho 59-198953). Unfortunately, potassium chloride and bittern have characteristic unpleasant tastes such as metallic taste, acrid taste, or bitterness, and the unpleasant tastes are also imparted to foods or drinks when they are used as substitutes of sodium chloride. Therefore, the amounts and fields of their use have been largely limited.

Accordingly, numerous attempts of adding organic acids, seasonings, sweeteners, etc. to potassium chloride have also been conducted in order to improve the taste of potassium chloride. As components to improve the unpleasant tastes of potassium chloride, for example, sugar alcohol (Japanese Unexamined Patent Application Publication No. Sho 62-32855), thaumatin (Japanese Unexamined Patent Application Publication No. Sho 63-137657), a calcium or magnesium salt of organic acid (Japanese Unexamined Patent Application Publication No. Hei 4-108358), carrageenan (Japanese Unexamined Patent Application Publication No. Hei 4-262758), a kombu extract (Japanese Unexamined Patent Application Publication No. Hei 6-7111), a non-sugar component concentrate obtained during sugar manufacturing or its processed product (Japanese Unexamined Patent Application Publication No. Hei 6-14742), a basic amino acid or basic peptide (WO2006/114918), and quinic acid, spiranthol, or an Allium plant extract (Japanese Unexamined Patent Application Publication No. 2010-4767) have been proposed. However, the improvement effects of these methods are also insufficient, and characteristic unpleasant tastes are also produced. Thus, there is a demand for further improvement.

### SUMMARY OF INVENTION

### Solution to Problem

Accordingly, it is an object of the present invention to increase the values of potassium salts as salt substitutes by improving the unpleasant tastes characteristic of the potassium salts without adversely affecting the salty tastes of the potassium salts. It is another object of the invention to provide a method for reducing the sodium content without decreasing the salty taste of a food or drink and to provide a sodium-reduced food or drink.

The present inventors have diligently studied in order to solve the foregoing problems and, as a result, have found that addition of a phthalide to a potassium salt or a potassium salt-containing food or drink improves the unpleasant tastes such as acrid tastes and metallic tastes characteristic of potassium salts and causes natural salty taste sensation. The invention has been completed upon this finding.

That is, the present invention provides the followings:

(1) a taste-improving agent for a potassium salt or a potassium salt-containing food or drink, the agent including a phthalide as an active ingredient;

(2) the taste-improving agent for a potassium salt or a potassium salt-containing food or drink according to (1), wherein the phthalide is at least one selected from sedanolide, sedanenolide, 3-butylidenephthalide, and 3-n-butylphthalide;

(3) the taste-improving agent for a potassium salt or a potassium salt-containing food or drink according to (1) or (2), wherein the phthalide is derived from an Umbelliferae plant extract;

(4) a taste-improving agent composition for a potassium salt or a potassium salt-containing food or drink, the composition containing the taste-improving agent according to any one of (1) to (3) such that the amount of the phthalide is 10 ppb to 1%;

(5) a method for improving the taste of a potassium salt or a potassium salt-containing food or drink, the method including adding the taste-improving agent according to any one of (1) to (3) to a potassium salt or a potassium salt-containing food or drink such that the amount of the phthalide is 0.01 ppb to 10 ppm; and

(6) the method for improving the taste of a potassium salt or a potassium salt-containing food or drink, the method including adding the taste-improving agent composition according to (4) to a potassium salt or a potassium salt-containing food or drink such that the amount of the phthalide is 0.01 ppb to 10 ppm.

The taste-improving agent of the present invention can improve unpleasant tastes such as acrid tastes and metallic tastes characteristic of potassium salts and can cause natural salty taste sensation. Therefore, the potassium salts can be used as substitutes for sodium chloride and can be contained in sodium-reduced foods.

### DESCRIPTION OF EMBODIMENTS

The phthalide used in the present invention means a compound having a phthalide skeleton and is one of compounds being characteristically present in essential oils of Umbelliferae plants and having a distinct spicy herbal smell. Specifically, the phthalide refers to, for example, sedanenolide, sedanolide, 3-n-butylphthalide, 3-butylidenephthalide, ligustilide, cnidilide, isocnidilide, neocnidilide, methyl sedanoate, or 3-butylhexahydrophthalide. Among these compounds, sedanenolide, sedanolide, 3-n-butylphthalide, and 3-butylidenephthalide are particularly preferred. These phthalides may be synthetic ones or may be purified from extracts or essential oils obtained by water or solvent extract or steam distillation of Umbelliferae plants by various known processes.

These compounds may be used alone or in a combination of one or more thereof. Furthermore, an essential oil or oleoresin of Umbelliferae plant such as Cnidium officinale, Angelica acutiloba, lovage, or celery, containing these compounds, may be used directly or may be used as an ingredient of a blended flavor.

The essential oil and oleoresin of Umbelliferae plant are natural raw materials and are therefore preferred as the taste-improving agent of the present invention from the viewpoints of safety and comfort. However, the essential oil and oleoresin contain, for example, hydrocarbons such as limonene, myrcene, β-caryophyllene, α-selinene, β-selinene, and γ-selinene, in addition to the phthalides, and thereby has distinct grassy aromas. These grassy aromas are favorable flavor in the use for obtaining flavor of Umbelliferae plant like the usual aromatic use. However, in the use as the taste-improving agent of the present invention, since the grassy aromas cause unnecessary grassy flavors, it is preferable to reduce or remove the grassy aromas. In particular, selinenes exhibit strong grassy aromas characteristic of Umbelliferae plants and are therefore desired to be reduced or removed as much as possible. Among these hydrocarbons, materials having relatively low boiling points, such as limonene (boiling point: 176° C., at atmospheric pressure), are readily reduced in their amounts by distillation at a temperature of 50° C. to 70° C. and a pressure of 500 to 1000 Pa using a common distillation column. Selinenes (e.g., β-selinene, boiling point: 260° C., at atmospheric pressure) and phthalides (e.g., sedanenolide, boiling point: 367° C., at atmospheric pressure) are sesquiterpenes and have relatively high boiling points as flavor compounds. Consequently, they remain in the stillage residue by distillation using a common distillation column, causing difficulty in separation. Accordingly, a method for removing selinenes, easily and at low cost, from essential oils of Umbelliferae plants or oleoresin is necessary.

As a method for reducing or removing hydrocarbons including selinenes from essential oils or oleoresin of Umbelliferae plants, various types of chromatography can be employed, but molecular distillation can be preferably employed as a simple and industrially applicable method. The molecular distillation is a method of purification performed by distillation under high-vacuum conditions so that evaporated molecules arrive at a cooling face without colliding with other molecules and condense thereon. Any type of apparatus or device that can carry out the method can be used, but a batch-type or continuous molecular distillation apparatus is common. These apparatuses are classified into a falling-film molecular distillation apparatus and a centrifugal-film molecular distillation apparatus, depending on the form. The centrifugal-film molecular distillation apparatus can form a stable thin film and is thereby preferred. In particular, a continuous centrifugal-film molecular distillation apparatus is preferred.

Hydrocarbons can be removed using a centrifugal-film molecular distillation apparatus under conditions of, for example, a temperature of 90° C. to 110° C. and a pressure of 10 to 30 Pa. Under these conditions, not only hydrocarbons having low boiling points, such as limonene, but also selinenes, which are sesquiterpenes, can be distilled to obtain phthalides as the stillage residue. When the raw material to be subjected to molecular distillation is an essential oil, a single time of molecular distillation can provide a taste-improving agent of the present invention containing 60% or more of phthalides as the stillage residue. Furthermore, when the raw material contains a nonvolatile component, such as oleoresin, a taste-improving agent of the present invention containing 60% or more of phthalides can be obtained as a stillage by removing hydrocarbons under the above-mentioned conditions and then subjecting the obtained stillage residue containing phthalides to molecular distillation again under conditions of a temperature of 140° C. to 160° C. and a pressure of 10 to 30 Pa to distillate the phthalides.

The molecular distillation itself is generally used not only for purification of fats and oils but also for removal of the terpene fraction of essential oils, such as orange, but application of the molecular distillation to purification of a taste-improving agent by reducing or removing unnecessary components such as limonene and selinenes from essential oils or oleoresin of Umbelliferae plants has not been known.

The present invention relates to a taste-improving agent for a potassium salt or a potassium salt-containing food or drink, and the taste-improving agent contains such a phthalide as an active ingredient. The phthalide contained in a potassium salt or a potassium salt-containing food or drink in a small amount that does not cause the spicy herbal smell characteristic of the phthalide can improve the unpleasant tastes such as acrid tastes and metallic tastes characteristic of potassium salts and causes natural salty taste sensation.

The taste-improving agent of the present invention can be added to a potassium salt or a potassium salt-containing food or drink, but the phthalides are oil-soluble and are therefore low in dispersibility in water and have a difficulty in being added to a potassium salt or a food or drink without modification. Accordingly, it is preferred to use the phthalides in a form of composition. Examples of the compositions include solutions in which the phthalides are dissolved in water-miscible organic solvents, emulsion formulations, and powder formulations.

Examples of the water-miscible organic solvent for dissolving the phthalides include ethanol, methanol, acetone, tetrahydrofuran, acetonitrile, 2-methyl ethyl ketone, 2-propanol, methyl ethyl ketone, glycerin, and propylene glycol. Among these solvents, ethanol and glycerin are particularly preferred from the viewpoint of the addition to foods or drinks.

The emulsion formulation can be prepared by emulsifying the phthalide with an emulsifying agent. The method of emulsification of the phthalide is not particular limited, and an emulsion having excellent stability can be obtained by emulsifying the phthalide with an emulsifying agent that has been used in foods and drinks using an emulsifying device such as a homomixer, a colloid mill, a rotary disk-type homogenizer, or a high-pressure homogenizer. Examples of the emulsifying agent include fatty acid monoglyceride, fatty acid diglyceride, fatty acid triglyceride, propylene glycol fatty acid ester, sucrose fatty acid ester, polyglycerin fatty acid ester, lecithin, chemically modified starch, sorbitan fatty acid ester, Quillaja extract, Arabic gum, tragacanth gum, guar gum, karaya gum, xanthane gum, pectin, arginic acid and its salts, carrageenan, gelatin, and casein. The amount of the emulsifying agent is not strictly regulated and can be varied in a broad range depending on the kind of the emulsifying agent used, but is usually about 0.01 to 100 parts by mass, preferably about 0.1 to 50 parts by mass, based on 1 part by mass of the phthalides. In addition, in order to stabilize the emulsification, the water-soluble solution for emulsification can contain one or more polyhydric alcohols such as glycerin, propylene glycol, sorbitol, maltitol, sucrose, glucose, trehalose, sugar solution, or reduced sugar syrup.

The thus-produced emulsion may be optionally dried into a powder formulation. In the powderization, a saccharide, such as trehalose, dextrin, sugar, lactose, glucose, sugar syrup, or reduced sugar syrup, can be further optionally added to the emulsion. The amount of the saccharide can be appropriately selected depending on the characteristics desired in the powder formulation.

In the present invention, the concentration of the phthalides in the taste-improving agent composition is not particularly limited, but is, for example, 10 ppb to 1%, preferably 100 ppb to 0.1%, more preferably 1 ppm to 0.1%, as the concentration of the phthalides.

The taste-improving agent composition for a potassium salt or a potassium salt-containing food or drink according to the present invention can appropriately contain other components. The components contained in the composition are not particularly limited, and examples thereof include flavor components, oil-soluble coloring agents, vitamins, and functional materials. The flavor component may be an extract from a natural matter such as, a natural essential oil, extract, oleoresin, or resinoid, a synthetic flavor compound, or a blended flavor thereof. Examples of the natural essential oil include citrus-based essential oils such as orange, lemon, lime, and grapefruit; and plant-based essential oils such as flower oil, peppermint oil, spearmint oil, and spice oil. Examples of the extract from a natural matter include oily extracts such as a cola nut extract, a coffee extract, a vanilla extract, a cocoa extract, a black tea extract, and a spice extract; and resinoid and oleoresins thereof. The synthetic flavor compound may be, for example, at least one selected from the group consisting of esters, alcohols, aldehydes, ketones, phenols, ethers, lactones, hydrocarbons, nitrogen- and/or sulfur-containing compounds, and acids that are described in, for example, “Actual condition survey on food flavor compounds in Japan” (Health Science Report, 2001: Japan Flavor and Fragrance Materials Association, published in March, 2002) or “Synthetic flavors: Chemistry and Product Information” (Mar. 22, 2005, enlarged ad revised edition, Motoichi Indo, The Chemical Daily Co., Ltd.). Examples of the oil-soluble coloring agent include oil-soluble natural coloring agents such as β-carotene, paprika color, annatto color, and chlorophyll. Examples of the oil-soluble vitamin include liver oil, vitamin A, vitamin A oil, vitamin D3, vitamin B2 butyric acid ester, vitamin E, and vitamin F. Examples of the functional material include docosahexaenoic acid (DHA), eicosapentaenoic acid (EPA), DHA- and/or EPA-containing fish oils, linoleic acid, γ-linolenic acid, α-linolenic acid, evening primrose oils, Borage oils, lecithin, octacosanol, rosemary extracts, sage extracts, γ-orizanol, β-carotene, palm carotene, and perilla oils.

The taste-improving agent or taste-improving agent composition of the present invention can be added to a potassium salt or a potassium salt-containing food or drink without limitation and is particularly suitable for improving the taste of potassium chloride, which is widely used as a substitute for salt.

When the taste-improving agent of the present invention is added to a potassium chloride itself to provide a taste-improved potassium salt, a water-miscible organic solvent solution containing the phthalide may be sprayed to a potassium salt, followed by drying; an emulsion composition containing the phthalide may be sprayed to a potassium salt, followed by drying; or a powder composition containing the phthalide may be mixed with a potassium salt powder.

The amount of the taste-improving agent or taste-improving agent composition of the present invention to be added to a potassium salt is not particularly limited and may be appropriately determined depending on, for example, the substitution ratio of the salt with potassium chloride or the like, the concentration of the potassium salt to be added, and other food raw materials. For example, the amount of the taste-improving agent or taste-improving agent composition is 1 ppb to 1000 ppm, preferably 10 ppb to 100 ppm, more preferably 0.1 to 100 ppm, as the amount of the phthalides based on the mass of the potassium salt.

The taste-improving agent or taste-improving agent composition of the present invention can be added to a potassium salt-containing food or drink such as a salt-reduced food containing potassium salt during the process of manufacturing the potassium salt-containing food or drink, the taste-improving agent of the present invention may be added to a food or drink already containing a potassium salt, or a mixture of the taste-improving agent of the present invention and a potassium salt may be added to a food or drink.

The blending ratio of the phthalides in the potassium-containing food or drink is, based on the food or drink as the final product, for example, 0.01 ppb to 10 ppm, preferably 0.1 ppb to 1 ppm, and more preferably 1 ppb to 1 ppm. In many practical cases, the phthalides are blended in the taste-improving agent composition as described above, and then the composition is added to a final product. In such cases, since the amount of the taste-improving agent composition in the final product is about 0.01% to 1%, the content of the phthalides in the taste-improving agent composition is about 10 ppb to 1%, preferably 100 ppb to 1000 ppm.

In the potassium salt-containing food or drink at the above-mentioned blending ratio, the unpleasant tastes such as metallic tastes and acrid tastes characteristic of potassium salts can be reduced, and natural salty taste sensation can be obtained.

The spicy aroma of the taste-improving agent itself is sensed with an increase in the amount of the taste-improving agent of the present invention. Accordingly, the amount of the taste-improving agent is usually regulated within the range that does not cause the spicy aroma sensation. However, when the flavor of the taste-improving agent itself is not a problem, the amount may be larger than the above-mentioned range.

The taste-improving agent of the present invention can reduce the unpleasant tastes such as metallic tastes and acrid tastes of potassium compounds and improve the tastes of not only foods and drinks containing potassium salts, such as potassium chloride, that are used as substitutes for salt but also foods or drinks containing, for example, potassium glutamate or potassium citrate.

The food or drink to which the taste-improving agent of the present invention is added may be any potassium-containing food or drink, and the taste-improving agent can be added to every food or drink of which taste needs to be improved. Examples of the food or drink include confectioneries such as rice crackers, arare crackers, okoshi rice crackers, rice cakes, stuffed buns, uiro bean pastes, bean pastes, sweet bean pastes, watery sweet bean pastes, nishikidama, jelly, Kasutera sponge cake, biscuits, crackers, potato chips, cookies, pies, puddings, butter cream, custard cream, cream puffs, waffles, sponge cake, donuts, chocolate, chewing gum, caramel, candy, and pastes such as peanut paste; breads, noodles, or boiled rice such as bread, Japanese noodles, ramen, sushi, fish/vegetable-containing boiled rice, fried rice, pilaf, gyoza skin, shumai skin, okonomiyaki, and takoyaki; pickled foods such as nukazuke, umeboshi, fukujinzuke, bettarazuke, senmaizuke, rakkyo, misozuke, takuanzuke, and the materials for such pickles; processed products containing seafoods, e.g., fish such as mackerel, sardine, saury, salmon, tuna, bonito, whale, flounder, sand lance, and ayu, squids such as flying squid, spear squid, cuttlefish, and firefly squid, octopuses such as common octopus and ocellated octopus, shrimp such as prawn, spot prawn, lobster, and black tiger prawn, crabs such as red king crab, snow crab, swimming crab, and horsehair crab, and shellfish such as Japanese littleneck, clam, scallop, oyster, and mussel, such as canned foods, boiled fish, salted and dried fish, tsukudani, fish sauce, minced fish, marine paste products (fish paste, kamaboko, fried kamaboko, crab leg kamaboko, etc.), fried fish, and tempura of seafoods; processed products containing livestock meats such as chicken, pork, beef, lamb, and horse meats, e.g., curry, stew, beef stew, ingredients of hayashi rice broth, meat sauce, mabo tofu, hamburger, gyoza, ham, meatballs, meat cubes, and canned meats; seasonings such as table salt, seasoning salt, soy sauce, powdered soy sauce, miso, powdered miso, moromi, hishio, furikake, ochaduke powder, margarine, mayonnaise, dressing, vinegar, sanbaizu, powdered sushi vinegar, powdered Chinese seasoning, tempura soup, noodle soup, sauces, ketchup, yakiniku sauce, curry roux, stew roux, powdered soup, Kamameshi ingredients, Japanese soup stock, compound seasonings, shin-mirin, and powder mixtures such as karaage powder and takoyaki powder; and other components, for example, dairy products such as cheese and butter, cooked foods such as chikuzenni, oden, and pot dishes, box lunch ingredients, side dishes, tomato juice, and sports drinks.

The taste-improving agent of the present invention is particularly suitable for foods and drinks in which an increase in substitution ratio with potassium chloride is desired for salt reduction, nevertheless the substitution ratio of the salt with potassium chloride is restricted due to the tastes, such as acrid taste, of potassium chloride. The taste-improving agent of the present invention is, among the above-mentioned foods and drinks, preferably suitable for kamaboko, ham, bread, salted and dried foods, pickles, umeboshi, soy sauce, Japanese soup stock, fish sauce, miso, sauce, soup, butter, margarine, mayonnaise, dressing, flavoring products, and snack candies.

The use of the taste-improving agent of the present invention can reduce the unpleasant tastes such as metallic taste or acrid taste of not only potassium chloride but also potassium-containing foods and drinks, such as foods and drinks containing, for example, potassium glutamate or potassium citrate, and thus improve their tastes.

The present invention will be more specifically described with reference to the following examples.

### EXAMPLES

### Example 1

### Preparation of Taste-Improving Agent Powder (1)

To 1 g of sedanenolide, 19.0 g of medium-chain triglyceride and 30 g of SAIB were added, and the mixture was dissolved to prepare an oil phase portion. Separately, 900 g of Pinedex (registered trademark) No. 2 (manufactured by Matsutani Chemical Industry Co., Ltd.) and 50 g of sucrose fatty acid ester having an HLB of 15 were dissolved in 680 g of soft water, and the solution was sterilized by heating at 85° C. for 15 min. This solution was cooled to about 40° C. and then 50 g of the previously prepared oil phase portion was poured to this solution while stirring with TK-homomixer (manufactured by Tokushu Kika Kogyo Co., Ltd.). The resulting mixture was further stirred at 5000 rpm for 5 min for emulsification to obtain 1690 g of an emulsion. This emulsion was dried using a spray dryer (manufactured by NIRO Atomizer AS: Mobile Minor (registered trademark)) at an inlet temperature of 150° C. and an outlet temperature of 80° C. to obtain 950 g of a taste-improving agent powder (Invention Product 1: containing 0.1% of sedanenolide).

### Example 2

### Improvement of Taste of Potassium Chloride (1)

Invention Product 1 was added to a 1% aqueous solution of potassium chloride such that the concentrations of sedanenolide were as those shown in Table 1, and the Invention Product 1-containing aqueous solution of potassium chloride and the Invention Product 1-free aqueous solution of potassium chloride were comparatively evaluated for flavor by ten trained panelists. The results are shown in Table 1.

TABLE 1
Sensory evaluation of sedanenolide-containing aqueous
solution of potassium chloride (1%)

| Concentration | | Evaluation | | | Flavor | |
|---|---|---|---|---|---|---|
| of sedanenolide | | A | B | N | judgment | Notes |
| Sedanenolide- | | | | | | |
| free | | | | | | |
| 1 | ppt | 10 | 0 | 0 | 0 | |
| 0.01 | ppb | 6 | 4 | 0 | 0 | |
| 0.1 | ppb | 3 | 6 | 1 | 0 | |
| 1 | ppb | 2 | 5 | 3 | 1 | |
| 0.01 | ppm | 3 | 3 | 4 | 1 | |
| 0.1 | ppm | 0 | 3 | 7 | 5 | |
| 1 | ppm | 0 | 4 | 6 | 3 | |
| 10 | ppm | 0 | 5 | 5 | 0 | a slight spicy aroma |
| | | | | | | was felt |

Evaluation:
A: the number of panelists who felt no difference from sedanenolide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 1, it was revealed that the metallic taste and the acrid taste of potassium chloride were reduced and the salty taste quality similar to the salty taste of salt was provided by adding 0.01 ppb to 10 ppm of sedanenolide to a 1% aqueous solution of potassium chloride. The amount of sedanenolide of about 0.1 ppb to 1 ppm showed particularly good results. The addition of sedanenolide in an amount of 10 ppm reduced the metallic taste and the acrid taste, but a slight spicy aroma was also felt. Some panelists felt a slight reduction in metallic taste or acrid taste even in a low concentration of 0.01 ppb, and it was thus revealed that sedanenolide showed an effect of reducing the metallic taste and the acrid taste of potassium chloride even in a low concentration.

### Example 3

### Preparation of Taste-Improving Agent Powder (2)

To 1 g of 3-n-butylphthalide, 19.0 g of medium-chain triglyceride and 30 g of SAIB were added, and the mixture was dissolved to prepare an oil phase portion. Separately, 900 g of Pinedex No. 2 and 50 g of sucrose fatty acid ester having an HLB of 15 were dissolved in 680 g of soft water, and the solution was sterilized by heating at 85° C. for 15 min. This solution was cooled to about 40° C. and then 50 g of the previously prepared oil phase portion was poured to this solution while stirring with TK-homomixer (manufactured by Tokushu Kika Kogyo Co., Ltd.). The resulting mixture was further stirred at 5000 rpm for 5 min for emulsification to obtain 1690 g of an emulsion. This emulsion was dried using a spray dryer (manufactured by NIRO Atomizer AS: Mobile Minor) at an inlet temperature of 150° C. and an outlet temperature of 80° C. to obtain 950 g of a taste-improving agent powder (Invention Product 2: containing 0.1% of 3-n-butylphthalide).

### Example 4

### Improvement of Taste of Potassium Chloride (2)

Invention Product 2 was added to a 1% aqueous solution of potassium chloride in the 3-n-butylphthalide concentrations shown in Table 2, and the Invention Product 2-containing aqueous solution of potassium chloride and the Invention Product 2-free aqueous solution of potassium chloride were comparatively evaluated for flavor by ten trained panelists. The results are shown in Table 2.

TABLE 2
Sensory evaluation of 3-n-butylphthalide-containing aqueous
solution of potassium chloride (1%)

| Concentration of | | Evaluation | | | Flavor | |
|---|---|---|---|---|---|---|
| 3-n-butylphthalide | | A | B | N | judgment | Notes |
| 3-n-butylphthalide- | | | | | | |
| free | | | | | | |
| 1 | ppt | 10 | 0 | 0 | 0 | |
| 0.01 | ppb | 8 | 2 | 0 | 0 | |
| 0.1 | ppb | 6 | 4 | 0 | 0 | |
| 1 | ppb | 2 | 6 | 2 | 1 | |
| 0.01 | ppm | 3 | 4 | 3 | 1 | |
| 0.1 | ppm | 1 | 6 | 3 | 5 | |
| 1 | ppm | 1 | 6 | 3 | 3 | |
| 10 | ppm | 0 | 6 | 4 | 0 | a slight spicy |
| | | | | | | aroma was felt |

Evaluation:
A: the number of panelists who felt no difference from 3-n-butylphthalide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 2, the results in 3-n-butylphthalide were almost the same as those of sedanenolide. That is, it was revealed that the metallic taste and the acrid taste of potassium chloride were reduced and the salty taste quality similar to the salty taste of salt was provided by adding 0.01 ppb to 10 ppm of 3-n-butylphthalide to a 1% aqueous solution of potassium chloride. The amount of 3-n-butylphthalide of about 0.1 ppb to 1 ppm showed particularly good results. The addition of 3-n-butylphthalide in an amount of 10 ppm reduced the metallic taste and the acrid taste, but a slight spicy aroma was also felt. Some panelists felt a slight reduction in metallic taste or acrid taste even in a low concentration of 0.01 ppb, and it was thus revealed that 3-n-butylphthalide showed an effect of reducing the metallic taste and the acrid taste of potassium chloride even in a low concentration.

### Example 5

### Preparation of Taste-Improving Agent Powder (3)

To 1 g of sedanolide, 19.0 g of medium-chain triglyceride and 30 g of SAIB were added, and the mixture was dissolved to prepare an oil phase portion. Separately, 900 g of Pinedex No. 2 and 50 g of sucrose fatty acid ester having an HLB of 15 were dissolved in 680 g of soft water, and the solution was sterilized by heating at 85° C. for 15 min. This solution was cooled to about 40° C. and then 50 g of the previously prepared oil phase portion was poured to this solution while stirring with TK-homomixer (manufactured by Tokushu Kika Kogyo Co., Ltd.). The resulting mixture was further stirred at 5000 rpm for 5 min for emulsification to obtain 1690 g of an emulsion. This emulsion was dried using a spray dryer (manufactured by NIRO Atomizer AS: Mobile Minor) at an inlet temperature of 150° C. and an outlet temperature of 80° C. to obtain 950 g of a taste-improving agent powder (Invention Product 3: containing 0.1% of sedanolide).

### Example 6

### Improvement of Taste of Potassium Chloride (3)

Invention Product 3 was added to a 1% aqueous solution of potassium chloride in the sedanolide concentrations shown in Table 3, and the Invention Product 3-containing aqueous solution of potassium chloride and the Invention Product 3-free aqueous solution of potassium chloride were comparatively evaluated for flavor by ten trained panelists. The results are shown in Table 3.

### [Table 3]

TABLE 3
Sensory evaluation of sedanolide-containing aqueous
solution of potassium chloride (1%)

| Concentration | | Evaluation | | | Flavor | |
|---|---|---|---|---|---|---|
| of sedanolide | | A | B | N | judgment | Notes |
| Sedanolide-free | | | | | | |
| 1 | ppt | 10 | 0 | 0 | 0 | |
| 0.01 | ppb | 7 | 3 | 0 | 0 | |
| 0.1 | ppb | 3 | 7 | 0 | 0 | |
| 1 | ppb | 2 | 4 | 4 | 0 | |
| 0.01 | ppm | 2 | 2 | 6 | 3 | |
| 0.1 | ppm | 1 | 3 | 6 | 4 | |
| 1 | ppm | 1 | 2 | 7 | 2 | |
| 10 | ppm | 0 | 2 | 8 | 1 | a slight spicy |
| | | | | | | aroma was felt |

Evaluation:
A: the number of panelists who felt no difference from sedanolide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 3, the results of sedanolide were also almost the same as those of sedanenolide and 3-n-butylphthalide. That is, it was revealed that the metallic taste and the acrid taste of potassium chloride were reduced and the salty taste quality similar to the salty taste of salt was provided by adding 0.01 ppb to 10 ppm of sedanolide to a 1% aqueous solution of potassium chloride. The amount of sedanolide of about 0.1 ppb to 1 ppm showed particularly good results. The addition of sedanolide in an amount of 10 ppm reduced the metallic taste and the acrid taste, but a slight spicy aroma was also felt. Some panelists felt a slight reduction in metallic taste or acrid taste even in a low concentration of 0.01 ppb, and it was thus revealed that sedanolide showed an effect of reducing the metallic taste and the acrid taste of potassium chloride even in a low concentration.

### Example 7

### Preparation of Taste-Improving Agent Powder (4)

To 1.3 g of an Umbelliferae plant extract (obtained by purifying an Umbelliferae plant essential oil by means of, for example, distillation: containing 8.0% of 3-n-butylphthalide, 65.5% of sedanenolide, and 3.5% of sedanolide as phthalides), 18.7 g of medium-chain triglyceride and 30 g of SAIB were added, and the mixture was dissolved to prepare an oil phase portion. Separately, 900 g of Pinedex No. 2 and 50 g of sucrose fatty acid ester having an HLB of 15 were dissolved in 680 g of soft water, and the solution was sterilized by heating at 85° C. for 15 min. This solution was cooled to about 40° C. and then 50 g of the previously prepared oil phase portion was poured this solution while stirring with TK-homomixer (manufactured by Tokushu Kika Kogyo Co., Ltd.). The resulting mixture was further stirred at 5000 rpm for 5 min for emulsification to obtain 1690 g of an emulsion. This emulsion was dried using a spray dryer (manufactured by NIRO Atomizer AS: Mobile Minor) at an inlet temperature of 150° C. and an outlet temperature of 80° C. to obtain 950 g of a taste-improving agent powder (Invention Product 4: containing 0.1% of phthalides).

### Example 8

### Improvement of Taste of Potassium Chloride (4)

Invention Product 4 was added to a 1% aqueous solution of potassium chloride in the phthalide concentrations shown in Table 4, and the Invention Product 4-containing aqueous solution of potassium chloride and the Invention Product 4-free aqueous solution of potassium chloride were comparatively evaluated for flavor by ten trained panelists. The results are shown in Table 4.

TABLE 4
Sensory evaluation of Umbelliferae plant extract-containing
aqueous solution of potassium chloride (1%)

| Concentration | | Evaluation | | | Flavor | |
|---|---|---|---|---|---|---|
| of phthalides | | A | B | N | judgment | Notes |
| Phthalide-free | | | | | | |
| 1 | ppt | 10 | 0 | 0 | 0 | |
| 0.01 | ppb | 8 | 2 | 0 | 0 | |
| 0.1 | ppb | 4 | 5 | 1 | 0 | |
| 1 | ppb | 3 | 6 | 1 | 0 | |
| 0.01 | ppm | 2 | 6 | 2 | 2 | |
| 0.1 | ppm | 0 | 5 | 5 | 5 | |
| 1 | ppm | 0 | 5 | 5 | 3 | |
| 10 | ppm | 0 | 5 | 5 | 0 | a slight spicy aroma |
| | | | | | | was felt |

Evaluation:
A: the number of panelists who felt no difference from phthalide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 4, it was revealed that the metallic taste and the acrid taste of potassium chloride were reduced and the salty taste quality similar to the salty taste of salt was provided by adding the Umbelliferae plant extract in an amount of 0.01 ppb to 10 ppm as phthalides to a 1% aqueous solution of potassium chloride. The amount of phthalides of about 0.1 ppb to 1 ppm showed particularly good results. The addition of phthalides in an amount of 10 ppm reduced the metallic taste and the acrid taste, but a slight spicy aroma was also felt. Some panelists felt a slight reduction in metallic taste or acrid taste even in a low concentration of 0.01 ppb, and it was thus revealed that phthalides showed an effect of reducing the metallic taste and the acrid taste of potassium chloride even in a low concentration.

### Example 9

### Salt/Potassium Chloride Composition

To 4 kg of water, 280 g of salt and 120 g of potassium chloride were added and were completely dissolved, followed by addition of 0.52 g of a 0.1% ethanol solution of an Umbelliferae plant extract (obtained by purifying an Umbelliferae plant essential oil by means of, for example, distillation: containing 8.0% of 3-n-butylphthalide, 65.5% of sedanenolide, and 3.5% of sedanolide as phthalides) to prepare an aqueous solution in which salt was mixed with a phthalide-containing potassium chloride composition. The aqueous solution was spray-dried at an inlet temperature of 120° C. and an outlet temperature of 80° C. to obtain 380 g of a powder mixture of potassium chloride and salt (Invention Product 5: containing 1 ppm of phthalides). Separately, 380 g of a phthalide-free powder mixture of potassium chloride and salt (Comparative Product 1) was prepared by the same process as that in Invention Product 5 except that the Umbelliferae plant extract was not added.

Over each sunny-side up egg, 0.3 g of Invention Product 5 or Comparative Product 1 was sprinkled respectively. The trained panelists ate the eggs and evaluated the taste. As a result, eight panelists recognized that Invention Product 5 reduced the metallic taste and the acrid taste characteristic of potassium chloride and had natural salty taste compared to Comparative Product 1. Thus, the effect of improving taste by the present invention was confirmed. Furthermore, no panelists felt foreign taste and foreign odor derived from the present invention product.

### Example 10

### Ramen Soup

### Soy Source Taste

According to formulations shown in Table 5, an ordinary ramen soup and a salt-reduced ramen soup were prepared. To the salt-reduced ramen soup, the taste-improving agent of Invention Product 1 or 4 was added such that the content of sedanenolide (Invention product 1) or phthalides (Invention Product 4) in the ramen soup was as that shown in Table 6. Sensory evaluation of the soup was performed by ten trained panelists using the taste-improving agent-free ramen soup as a control.

TABLE 5
Ramen soup formulation

Ingredients content (g)

| | Ordinary | Salt-reduced ramen |
|---|---|---|
| Raw material | ramen soup | soup |
| Salt | 360 | 215 |
| Potassium chloride | 0 | 145 |
| Powdered soy source | 220 | 220 |
| Sodium L-glutamate | 120 | 120 |
| Meat extract powder | 100 | 100 |
| Sugar | 80 | 80 |
| Seafood extract powder | 30 | 30 |
| Vegetable extract powder | 20 | 20 |
| Spice powder | 10 | 10 |
| Sodium succinate | 5 | 5 |
| Dextrin | 55 | 55 |
| Water | 59000 | 59000 |
| Total | 60000 | 60000 |
| Sodium chloride conc. | 0.80% | 0.56% |
| Potassium chloride conc. | 0% | 0.24% |

TABLE 6

| | | | | Salt-reduced ramen soup | | | | | |
|---|---|---|---|---|---|---|---|---|---|
| | | Ordinary ramen | | Phthalide- | | Invention | | Invention | |
| | | soup | | free | | Product 1 | | Product 4 | |
| | | metallic | | metallic | | metallic | | metallic | |
| Concentration | | or acrid | salty | or acrid | salty | or acrid | salty | or acrid | salty |
| of phthalides | | taste | taste | taste | taste | taste | taste | taste | taste |
| Phthalide-free | | Excellent | + | Poor | − | Poor | − | Poor | − |
| 1 | ppt | | | | | Poor | − | Poor | − |
| 0.01 | ppb | | | | | Fair | − | Fair | − |
| 0.1 | ppb | | | | | Good | − | Good | − |
| 1 | ppb | | | | | Good | − | Good | − |
| 0.01 | ppm | | | | | Excellent | +/− | Excellent | +/− |
| 0.1 | ppm | | | | | Excellent | + | Excellent | + |
| 1 | ppm | | | | | Excellent | ++ | Excellent | ++ |
| 10 | ppm | | | | | Excellent | ++ | Excellent | ++ |

Evaluation of metallic or acrid taste:
Excellent: hardly felt
Good: slightly felt
Fair: moderately felt
Poor: strongly felt
Evaluation of salty taste:
++: slightly stronger than salt
+: almost the same as salt
+/−: slightly weaker than salt
−: moderately weaker than salt

As shown in Table 6, the addition of phthalides as the taste-improving agent of the present invention to the salt-reduced ramen soup has an effect of reducing the metallic taste characteristic of potassium chloride and also has an effect of enhancing the salty taste. Furthermore, the agent did not adversely affect the flavors characteristic of meats, seafoods, vegetables, spices, and so on, and no panelists felt foreign taste and foreign odor derived from the present invention product.

### Example 11

### Lightly Pickling Seasoning

The taste-improving agent composition of Invention Product 2 was added to 100 mL of a commercially available salt-reduced lightly pickling seasoning (liquid, containing 3.5% of salt and 2.5% of potassium chloride) such that the concentrations of 3-n-butylphthalide were as those shown in Table 7 to prepare 3-n-butylphthalide-containing and 3-n-butylphthalide-free salt-reduced lightly pickling seasonings. Cucumber was sufficiently washed with water and cut into a thickness of 2 to 3 mm, and each 200 g of the cucumber was put in a polyethylene bag. The 3-n-butylphthalide-containing or 3-n-butylphthalide-free salt-reduced lightly pickling seasoning was put in the polyethylene bag containing the cucumber. The content in the bag was well stirred and kneaded with a hand from outside the bag. The air in each bag was sufficiently removed, and the bags containing cucumber were stored in a refrigerator for 3 hr. Then, the cucumber was sufficiently washed with water. The lightly pickled cucumber was comparatively evaluated for flavor by ten trained panelists using the 3-n-butylphthalide-free cucumber as a control. The results are shown in Table 7.

TABLE 7
Sensory evaluation of 3-n-butylphthalide-containing salt-
reduced lightly pickling seasoning

| Concentration of | | Evaluation | | | Flavor | |
|---|---|---|---|---|---|---|
| 3-n-butylphthalide | | A | B | N | judgment | Notes |
| 3-n-butylphthalide- | | | | | | |
| free | | | | | | |
| 1 | ppt | 10 | 0 | 0 | 0 | |
| 0.01 | ppb | 8 | 2 | 0 | 0 | |
| 0.1 | ppb | 7 | 2 | 1 | 0 | |
| 1 | ppb | 4 | 4 | 2 | 1 | |
| 0.01 | ppm | 3 | 3 | 4 | 1 | |
| 0.1 | ppm | 0 | 4 | 6 | 4 | |
| 1 | ppm | 0 | 4 | 6 | 4 | |
| 10 | ppm | 0 | 5 | 5 | 0 | a slight spicy |
| | | | | | | aroma was felt |

Evaluation:
A: the number of panelists who felt no difference from 3-n-butylphthalide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 7, it was revealed that the metallic taste and the acrid taste of the cucumber pickled with the salt-reduced lightly pickling seasoning were reduced and natural salty taste was obtained by adding 0.01 ppb to 10 ppm of 3-n-butylphthalide. The amount of 3-n-butylphthalide of about 1 ppb to 1 ppm showed particularly good results. The addition of 3-n-butylphthalide in an amount of 10 ppm reduced the metallic taste and the acrid taste, but a slight spicy aroma was also felt. Some panelists felt a reduction in metallic taste or acrid taste even in a low concentration of 0.01 ppb, and it was thus revealed that 3-n-butylphthalide showed an effect of reducing the metallic taste and the acrid taste even in a low concentration.

### Example 12

### Salted Fermented Squid with Reduced Salt

The taste-improving agent composition of Invention Product 3 was added to a commercially available salt-reduced salted fermented squid (containing 3% of salt and 3% of potassium chloride) such that the concentrations of sedanolide were as those shown in Table 8 to prepare sedanolide-containing and sedanolide-free salt-reduced salted fermented squid. The salted fermented squid with reduced salt was comparatively evaluated for flavor by ten trained panelists using the sedanolide-free salted fermented squid as a control. The results are shown in Table 8.

TABLE 8
Sensory evaluation of sedanolide-containing salted
fermented squid with reduced salt

| Concentration | | Evaluation | | | Flavor | |
|---|---|---|---|---|---|---|
| of sedanolide | | A | B | N | judgment | Notes |
| sedanolide-free | | | | | | |
| 1 | ppt | 10 | 0 | 0 | 0 | |
| 0.01 | ppb | 5 | 5 | 0 | 0 | |
| 0.1 | ppb | 4 | 5 | 1 | 0 | |
| 1 | ppb | 3 | 4 | 3 | 1 | |
| 0.01 | ppm | 2 | 3 | 5 | 1 | |
| 0.1 | ppm | 0 | 2 | 8 | 5 | |
| 1 | ppm | 0 | 4 | 6 | 3 | |
| 10 | ppm | 0 | 5 | 5 | 0 | a slight spicy aroma |
| | | | | | | was felt |

Evaluation:
A: the number of panelists who felt no difference from sedanolide-free,
B: the number of panelists who felt a slight reduction in metallic taste or acrid taste,
N: the number of panelists who felt a great reduction in metallic taste or acrid taste, and
Flavor judgment: the number of panelists who judged that the salty taste quality was the highest and most similar to that of salt.

As shown in Table 8, it was revealed that the metallic taste and the acrid taste of the salted fermented squid with reduced salt were reduced and natural salty taste was obtained by adding 0.01 ppb to 10 ppm of sedanolide. The amount of sedanolide of about 1 ppb to 1 ppm showed particularly good results. The addition of sedanolide in an amount of 10 ppm reduced the metallic taste and the acrid taste, but a slight spicy aroma was also felt. Some panelists felt a reduction in metallic taste or acrid taste even in a low concentration of 0.01 ppb, and it was thus revealed that sedanolide showed an effect of reducing the metallic taste and the acrid taste even in a low concentration.

1. A taste-improving agent for a potassium salt or a potassium salt-containing food or drink, the agent comprising a phthalide as an active ingredient.

2. The taste-improving agent for a potassium salt or a potassium salt-containing food or drink according to claim 1, wherein the phthalide is at least one selected from sedanolide, sedanenolide, 3-butylidenephthalide, and 3-n-butylphthalide.

3. The taste-improving agent for a potassium salt or a potassium salt-containing food or drink according to claim 1, wherein the phthalide is derived from an Umbelliferae plant extract.

4. A taste-improving agent composition for a potassium salt or a potassium salt-containing food or drink, the composition comprising a taste-improving agent according to claim 1 such that the amount of the phthalide is 10 ppb to 1%.

5. A method for improving the taste of a potassium salt or a potassium salt-containing food or drink, the method comprising adding a taste-improving agent according to claim 1 to a potassium salt or a potassium salt-containing food or drink such that the amount of the phthalide is 0.01 ppb to 10 ppm.

6. A method for improving the taste of a potassium salt or a potassium salt-containing food or drink, the method comprising adding a taste-improving agent composition according to claim 4 to a potassium salt or a potassium salt-containing food or drink such that the amount of the phthalide is 0.01 ppb to 10 ppm.
